(19) United States
(12) Patent Application Publication
(10) Pub. No.: US 2008/0104715 A1
(43) Pub. Date: May 1, 2008

(54) Image processing apparatus, image processing method and recording medium

(75) Inventors: Masaaki Saka, Toyohashi-shi (JP); Kazuhiro Ishiguro, Toyohashi-shi (JP); Hideyuki Toriyama, Toyokawa-shi (JP); Hiroyuki Suzuki, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc, Tokyo (JP)

(21) Appl. No.: 11/976,205

(22) Filed: Oct. 22, 2007

(30) Foreign Application Priority Data
Oct. 31, 2006 (JP) 2006-297104

(51) Int. Cl. G06F 19/00; H04L 9/32

(52) U.S. Cl. 726/31

(57) ABSTRACT

An image processing apparatus, comprising: a document reader that reads images of a document; a printer that prints on a sheet, image data read out from the document by said document reader; a mode setter that enables the N in 1 mode to print images of N pages of document on one sheet; and a security code giver that gives a security code to each print area on said sheet, in which the image data read out from the document is to be printed, if the N in 1 mode is enabled by said mode setter.

This application claims priority under 35 U.S.C. §119 to Japanese Patent Application No. 2006-297104 filed on Oct. 31, 2006, the entire disclosure of which is incorporated herein by reference in its entirety.

### BACKGROUND OF THE INVENTION

1. Field of the Invention

The present invention relates to an image processing apparatus that is applied to MFPs (Multi Function Peripherals), a digital multifunctional complex machine, capable of creating a document with a given security code or detecting the given security code of the document, an image processing method, and a recording medium having an image processing program recorded therein to make a computer in the image processing apparatus execute image processing.

2. Description of the Related Art

The following description sets forth the inventor's knowledge of related art and problems therein and should not be construed as an admission of knowledge in the prior art.

In recent years, paper document security has been enhanced so as to prevent paper copied from a confidential document by a copy machine, etc. from being leaked to outsiders, and paper copied from an original document from being misused as the original document itself.

According to a heretofore known art, reading of a confidential document is restricted by a security code that is given to each side of sheet thereof.

In addition, according to another heretofore known art, a document is prohibited/permitted to be copied, by a ground pattern that is given thereto and a password.

However, with these arts mentioned right above, security is set only by sheets to be outputted or by sides of sheet of original document. When images of N pages of a document are copied on a sheet by the N in 1 mode to print N pages of document on one sheet, only one security code is given to the whole sheet, in other words, information is not given to each image on the sheet. Therefore, these arts are not convenient because the arts do not provide a good solution when a user would like to prohibit from being outputted, only one image from a certain page among those from N pages of document, which are printed by N in 1 mode on a sheet, in other words, only one image from a page including text, images, confidential information, personal information, etc. that should be protected by copyrights.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an object of the present invention to provide a useful image processing apparatus capable of giving a security code to each area on a sheet, in which image data read out from N pages of a document is to be printed by the N in 1 mode.

It is another object of the present invention to provide an image processing method capable of giving a security code to each area on a sheet, in which image data read out from N pages of a document is to be printed by the N in 1 mode.

It is yet another object of the present invention to provide a recording medium having an image processing program recorded therein to make a computer in the image processing apparatus execute image processing by the image processing method.

It is yet another object of the present invention to provide an image processing apparatus capable of detecting a security code given to each of a plurality of areas on a sheet, in which images are printed by the N in 1 mode, and controlling printing of image data read out from each of the areas.

It is yet another object of the present invention to provide an image processing method capable of detecting a security code given to each of a plurality of areas on a sheet, in which images are printed by the N in 1 mode, and controlling printing of image data read out from each of the areas.

It is yet another object of the present invention to provide a recording medium having an image processing program recorded therein to make a computer in the image processing apparatus execute image processing by the image processing method.

A first aspect of the present invention is an image processing apparatus, comprising:
a document reader that reads images of a document;
a printer that prints on a sheet, image data read out from the document by said document reader;
a mode setter that enables the N in 1 mode to print images of N pages of document on one sheet; and
a security code giver that gives a security code to each print area on said sheet, in which the image data read out from the document is to be printed, if the N in 1 mode is enabled by said mode setter.

A second aspect of the present invention is an image processing apparatus, comprising:
a document reader that reads images printed in a plurality of areas in a document by the N in 1 mode to print images of N pages of document on one sheet;
a printer that prints on a sheet, image data read out from the document by said document reader;
a security code detector that detects a security code given to each of the plurality of areas in said document; and
a controller that makes said printer print image data read out from each of the areas, in a particular way depending on the security code detected out by said security code detector.

A third aspect of the present invention is an image processing method, comprising:
reading images of a document;
enabling the N in 1 mode to print images of N pages of document on one sheet; and giving a security code by the N in 1 mode to each area on a sheet, in which image data read out from the document is to be printed, if the N in 1 mode is enabled by said mode setter.

A fourth aspect of the present invention is an image processing method, comprising:
reading images printed in a plurality of areas in a document by the N in 1 mode to print images of N pages of document on one sheet;
printing image data read out from said document on a sheet;
detecting a security code given to each of the plurality of areas in said document; and making said printer print image data read out from each of the areas, in a particular way depending on said detected security code.

A fifth aspect of the present invention is a recording medium having an image processing program recorded therein to make a computer in the image processing apparatus execute:
reading images of a document;
enabling the N in 1 mode to print images of N pages of document on one sheet; and giving a security code to each area on a sheet, in which image data read out from the document is to be printed, if the N in 1 mode is enabled by said mode setter.

A sixth aspect of the present invention is a recording medium having an image processing program recorded therein to make a computer in the image processing apparatus execute:
reading images printed in a plurality of areas in a document by the N in 1 mode to print images of N pages of document on one sheet;
printing image data read out from said document on a sheet;
detecting a security code given to each of the plurality of areas in said document; and making said printer print image data read out from each of the areas, in a particular way depending on said detected security code.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram showing an electrical configuration of a MFP, to which an image processing apparatus according to one embodiment of the present invention is applied;

FIG. 2 is a block diagram showing a functional configuration of an image processor that is used in the image processing apparatus shown in FIG. 1;

FIG. 3 is a view to explain a basic configuration to give a security code to each image, when a document is copied on a sheet by the N in 1 mode;

FIG. 4 is a view showing one example of a ground pattern that corresponds to a security code;

FIG. 5 is a view to explain a configuration to give a security code to each image read out from a document, when the document is copied on a sheet by the N in 1 mode;

FIG. 6 is a flowchart showing a procedure to give a security code to each image read out from a document, when the document is copied on a sheet by the 2 in 1 mode;

FIG. 7 is a view to explain operations performed if a detected security code is “copy prohibit”;

FIG. 8 is view to explain other operations performed if a detected security code is “copy prohibit”;

FIG. 9 is a plain view of an operation panel with a message displayed on a display thereof, if a security code “copy prohibit” is detected out;

FIG. 10 is a plain view of an operation panel with some areas displayed on a display, which are detected as the copy prohibit areas when a document having a ground pattern given to each area therein is copied on a sheet;

FIG. 11 is a flowchart showing a procedure to detect a security code;

FIG. 12 is a plain view of an operation panel displaying an image of a document and options of information to be embedded in a ground pattern for the image; and

FIG. 13 is a plain view of an operation panel displaying a list of images of a document and options of information to be embedded in a ground pattern for each of the images.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

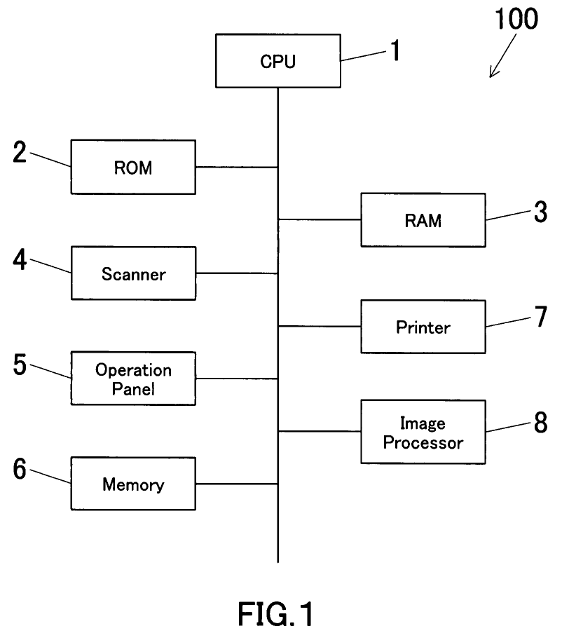

As shown in the block diagram in FIG. 1, a MFP 100 comprises a CPU 1, a ROM 2, a RAM 3, a scanner 4, an operation panel 5, a memory 6, a printer 7 and an image processor 8.

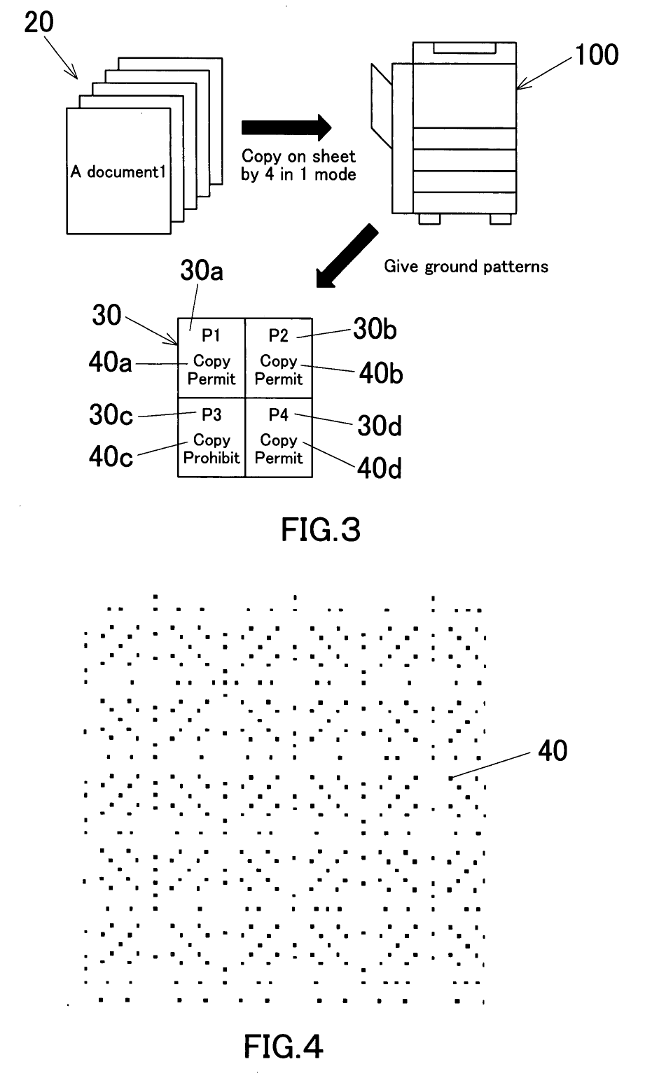

The CPU 1 controls all operations performed in the MFP 100. Specifically, it controls following operations in this embodiment. If the security code giving mode and the N in 1 mode to print N pages of document on one sheet are enabled as shown in FIG. 3 (the 4 in 1 mode is employed in FIG. 3), image data read out from a document 20 is printed in areas 30a through 30d on a sheet 30, at the same time, security codes 40a through 40d are given to the areas 30a through 30d on the sheet 30, respectively. On the other hand, if the security code giving mode is enabled and the N in 1 mode is not enabled, image data read out from each page of the document 20 is printed on the sheet 30, at the same time, one security code is given to the whole sheet 30.

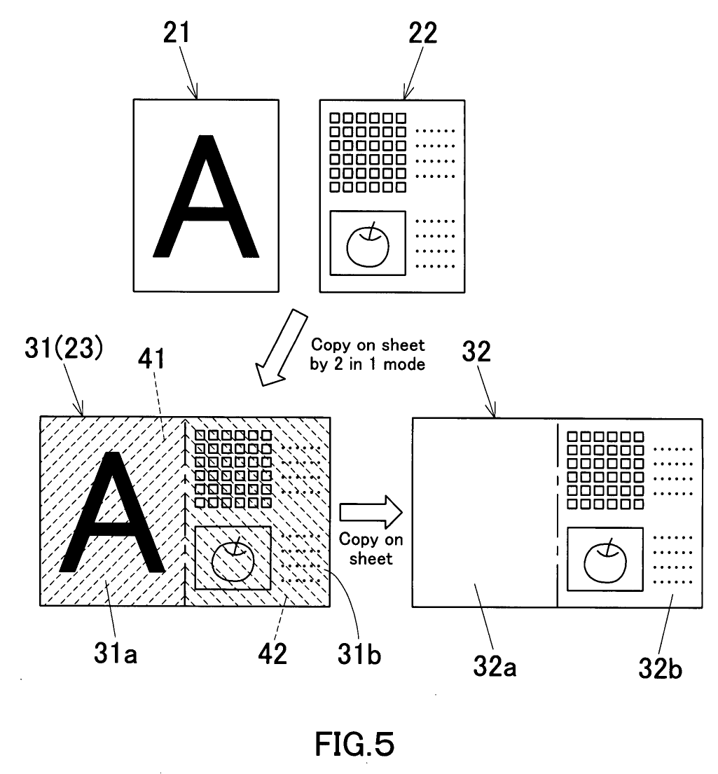

In this embodiment, a ground pattern 40, which corresponds to the security code to be given to the sheet 30, is given behind image as shown in FIG. 4. As a matter of course, the security code can be of another type such as a barcode and a wireless IC chip, besides a ground pattern. Further, the security code can be detected by an appropriate method depending on its type.

The ROM 2 is a memory that stores an operation program executed by the CPU 1, and the RAM 3 is a memory that provides a working space for the CPU 1 to execute the operation program.

The scanner 4 reads images of a document that is set on a document table not shown in Figure or automatically transferred by an automatic document feeder neither shown in Figure, and then transmits image data read out from the document to the image processor 8.

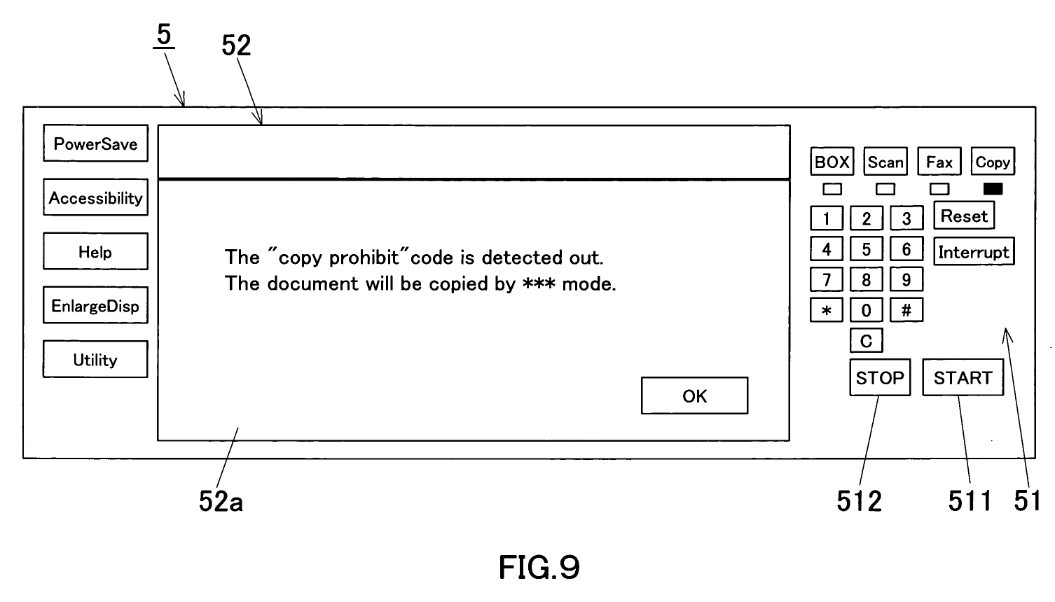

As shown in FIG. 9, the operation panel 5 comprises a key pad 51 for various entry operations and a display 52 that is a LCD, etc. A touch panel can be embedded in the display 52. As shown in FIG. 9, the key pad 51 has a start key 511 and a stop key 512.

In this embodiment, a user performs various operations using the operation panel 5. For example, he/she enables the N in 1 mode, enables/disables the mode to give a security code (a ground pattern) to each area, enters a security code for each area if the mode to give a security code is enabled, enabling/disabling the mode to detect a security code given to a document, and enabling the mode to perform an operation if the mode to detect a security code is enabled and the detected security mode is “copy prohibit”. Then, the CPU 1 accepts the user setting and entry operations above and executes processing according thereto.

The memory 6 records various types of data and programs therein. And a hard disk, for example, is used as the memory 6.

The printer 7 prints image data read out by the scanner 4 then processed in a predetermined manner and the ground pattern 40 corresponding to a security code, according to job conditions.

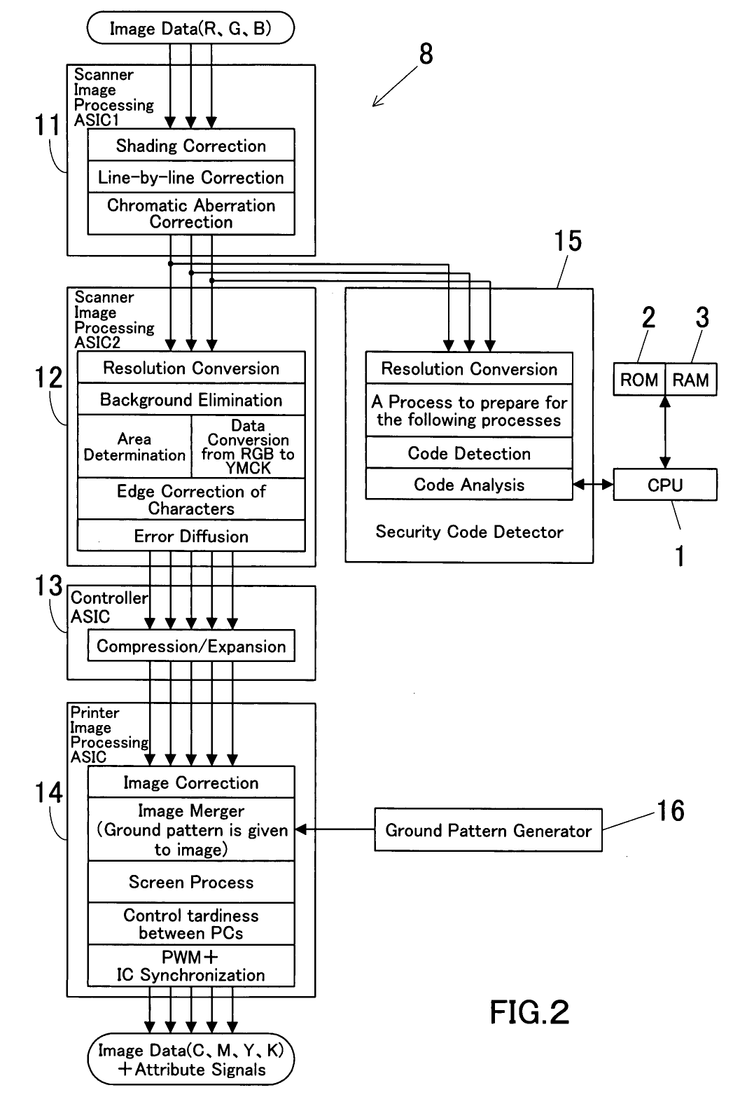

The image processor 8 processes the image data read out from a document by the scanner 4, in a predetermined manner. The process will be explained in details with reference to FIG. 2.

As shown in FIG. 2, the image processor 8 comprises a first scanner image processor 11, a second scanner image processor 12, a controller 13, a printer image processor 14, a security code detector 15, a ground pattern generator 16, etc.

The first scanner image processor 11 performs shading correction, line-by-line correction, chromatic aberration correction, etc., on the image data (R, G, B) read out by the scanner 4.

The second scanner image processor 12 performs resolution conversion, background elimination, area determination, data conversion from R, G, B to Y, M, C, K, edge correction of characters, error diffusion, etc., on the image data incoming from the first scanner image processor 11.

The controller 13 compresses/expands the image data processed by the second scanner image processor 12.

The printer image processor 14 performs processes to prepare for printing on the image data incoming via the controller 13, and those are image correction, image merger, a screen process, etc. Then, the image data (R, G, B) is outputted to the printer 7 together with given attribute information.

The image merger performed by the printer image processor 14 corresponds to a process to merge the ground pattern 40 to the image data read out from the document 20. In this way, the ground pattern 40 generated by the ground pattern generator 16 is given to the image data read out by the scanner 4, in other words, it is embedded as a background behind image.

Meanwhile, the image data processed by the first scanner image processor 11 is also inputted into the security code detector 15. The security code detector 15 picks up the ground pattern 40 from the image data incoming via the first scanner image processor 11 so as to detect a security code. Then, some known processes such as resolution conversion, a process to prepare for the following processes (pre-processes), code detection, code analysis, etc. are performed thereby under the control of the CPU 1.

Hereinafter, one embodiment will be explained with reference to FIG. 5, wherein the MFP 100 prints image data read out from the document 20 having N pages (e.g. two pages) in a plurality of areas on a sheet, and simultaneously gives a security code (the ground pattern 40) to each of the areas, if the N in 1 mode (for example, the 2 in 1 mode) is enabled.

As shown in FIG. 5, when two pages, a document 21 and a document 22, are copied on a sheet 31 by the 2 in 1 mode, an image from the document 21 is printed in an area 31a located in the left half of the sheet 31 and an image from the document 22 is printed in an area 31b located in the right half of the sheet 31. Further, different security codes are given to the area 31a and the area 31b, respectively, as a ground pattern 41 and a ground pattern 42, if the mode to give a security code is enabled.

Meanwhile, the ground pattern 41 indicates “copy prohibit” and the ground pattern 42 indicates “copy permit”, for example. The security code to be given as a ground pattern is not limited to “copy prohibit” or “copy permit”, but it can be other information such as coordinate information of the image data.

In this way, image data read out from the documents 21 and 22 are printed in the areas 31a and 31b on the sheet 31, respectively. In other words, a new document 23 that is the sheet 31 having a security code (the ground patterns 41 and 42) given to each of the areas 31a and 31b is obtained.

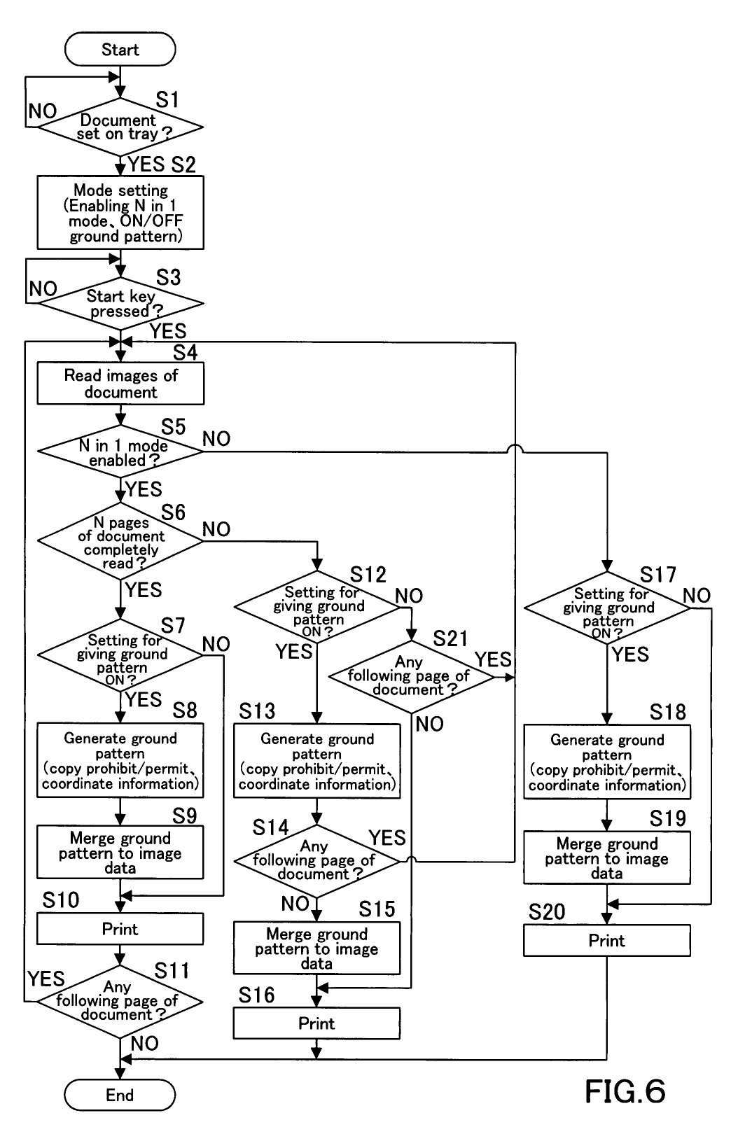

Hereinafter, a procedure will be explained with reference to the flowchart in FIG. 6, wherein security codes (the ground patterns 41 and 42) are given to the areas 31a and 31b respectively, when image data read out from the documents 21 and 22 are printed on a sheet by the N in 1 mode. The processes are executed by the CPU 1 according to an operation program recorded in a recording medium such as the ROM 2. In this embodiment, a document is automatically transferred by an automatic document feeder.

As shown in FIG. 6, the routine waits until a document is set on a tray of an automatic document feeder of the scanner 4, in Step S1. If a document is set (YES in Step S1), mode settings are performed according to user setting or entry operations. As previously mentioned, the mode settings are enabling the N in 1 mode, enabling/disabling (ON/OFF) the mode to give a ground pattern (a security code), setting information to be embedded in a ground pattern if the mode to give a ground pattern is enabled, and others.

The information to be embedded in a ground pattern is set for each page of document. For example, a user enters “copy prohibit”, etc., for a particular page of the document, via the operation panel 5.

Subsequently, the routine waits until the start key 511 is pressed, in Step S3. If the start key 511 is pressed (YES in Step S3), images of a document P are started to be read in Step S4. If one page of the document is completely read, it is judged in Step S5 whether or not the N in 1 mode is enabled.

If the N in 1 mode is enabled (YES in Step S5), it is judged in Step S6 whether or not N pages of the document are completely read. If N pages of the document are not yet completely read (NO in Step S6), the routine proceeds to Step S12 in which it is judged whether or not the mode to give a ground pattern is enabled, in other words, the mode to give a security code is enabled. If the mode to give a ground pattern is not enabled (NO in Step S12), it is judged in Step S21 whether or not there is any following page of the document, and if there is any following page (YES in Step S21), the routine returns to Step S4. If there is no more following page (NO in Step S21), less than N pieces of image data already read out from the document are printed on one sheet in Step S16, then the routine terminates.

If the mode to give a ground pattern is enabled (YES in Step S12), a ground pattern with an embedded security code is created in Step S13. The security code to be embedded in a ground pattern is “copy prohibit” “copy permit” coordinate information, etc., as previously mentioned. Then, it is judged in Step S14 whether or not there is any following page of the document, and if there is any following page (YES in Step S14), the routine returns to Step S4.

If there is no more following page of the document (NO in Step S14), then in Step S15, ground patterns generated according to the set information are given and merged to the less than N pieces of image data already read out from the document, respectively. In Step S16, the merged image data are printed on one sheet, and then the routine terminates.

Back to Step S6, if N pages of the document are completely read (YES in Step S6), it is judged in Step S7 whether or not the mode to give a ground pattern is enabled.

If the mode to give a ground pattern is enabled (YES in Step S7), then in Step S8, a ground pattern is generated for image data read out from the page N of the document.

In Step S9, generated ground patterns are given and merged to N pieces of image data read out from the document respectively, and then the N pieces of merged image data are printed on one sheet in Step S10.

Back to Step S7, if the mode to give a ground pattern is not enabled (NO in Step S7), the routine skips the Steps for generating and giving a ground pattern, and directly proceeds to Step S10 in which the N pieces of merged image data are printed on one sheet.

Subsequently, it is judged in Step S11 whether or not there is any following page of the document, and if there is any following page (YES in Step S11), the routine returns to Step S4. If there is no more following page (NO in Step S11), the routine terminates.

Back to Step S5, if the N in 1 mode is not enabled (NO in Step S5), it is judged in Step S17 whether or not the mode to give a ground pattern is enabled. If the mode to give a ground pattern is enabled (YES in Step S17), a ground pattern is generated in Step S18. Then in Step S19, the generated ground pattern is given and merged to the image data read out from the document. The merged image data is printed on a sheet in Step 20, and then the routine terminates. In this case, one security code is given to one whole sheet.

Back to Step S17, if the mode to give a ground pattern is not enabled (NO in Step S17), the routine directly proceeds to Step S20 in which image data read out from the document is printed on a sheet.

As described above, in this embodiment, when images of N pages of a document are copied on a sheet by the N in 1 mode, a security code is given to each area, in which image data read out from each of the pages is to be outputted, if the mode to give a security code is enabled. In other words, information such as “copy prohibit” or “copy permit” is given to each area on a sheet to be outputted, or by pages of an original document, which would contribute to flexibility of document security management.

Hereinafter, one embodiment will be explained with reference to FIG. 5, wherein a document 23 is copied on a sheet, and the document 23 is a sheet having image data read out from N pages of an original document printed by the N in 1 mode, and also having a security code given to each area therein.

When the document 23 is copied on a sheet 32, the ground patterns 41 and 42 are detected from the areas 31a and 31b of the document 23, respectively. If the information detected from the area 31a is “copy prohibit”, a blank space is outputted in the area 32a on the sheet 32, which corresponds to the area 31a, as shown in FIG. 5. In this way, an image protected by the “copy prohibit” security code is not outputted on a sheet, which prevents the image from being leaked to outsides.

Alternatively, a print job to print the document is canceled if the detected security code is “copy prohibit”.

Alternatively, instead of outputting a blank space in the area 32a, an operation can be performed on the image in order to let a user know “copy prohibit” and then the image is printed, or the sheet 32 is outputted without a strange blank space to look better.

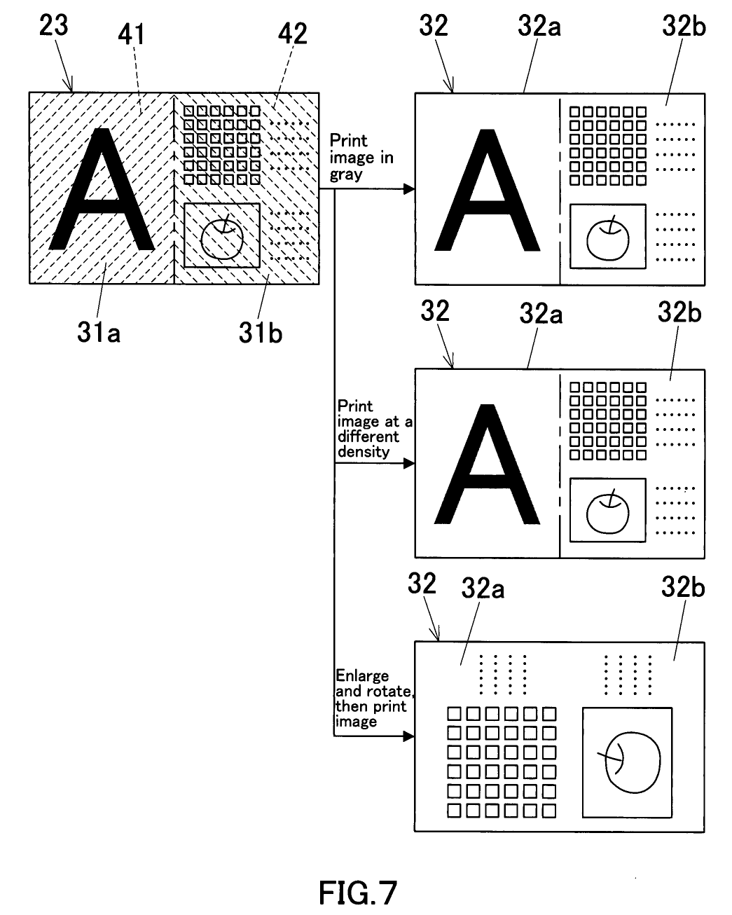

Hereinafter, some examples of the outputted sheet 32 right above will be explained with reference to FIG. 7.

When the document 23 is copied on the sheet 32, an image from the area 31a is printed in a different color on the sheet 32 as shown in the upper right region of FIG. 7, if the detected ground pattern 41 is of “copy prohibit”. In this embodiment, a full-color image is printed in gray on the sheet.

Alternatively, an image from the area 31a is printed at a different density (for example, at a lower density) in the area 32a if the ground pattern 41 detected from the area is of “copy prohibit”, as shown in the vertical middle right region of FIG. 7.

Alternatively, an image from the area 31a is enlarged or reduced, then printed in the area 32a if the ground pattern 41 detected from the area is of “copy prohibit”, although it is not shown in Figure.

Alternatively, an image from the area 31a is not printed; instead, a permitted image from the area 31b is rotated then printed in the center of the sheet 32, or enlarged then printed so as to fill in the whole sheet 32, if the ground pattern 41 detected from the area 31a is of “copy prohibit”. As a matter of course, it can be both rotated and enlarged, then printed on the sheet, as shown in the lower right region of FIG. 7.

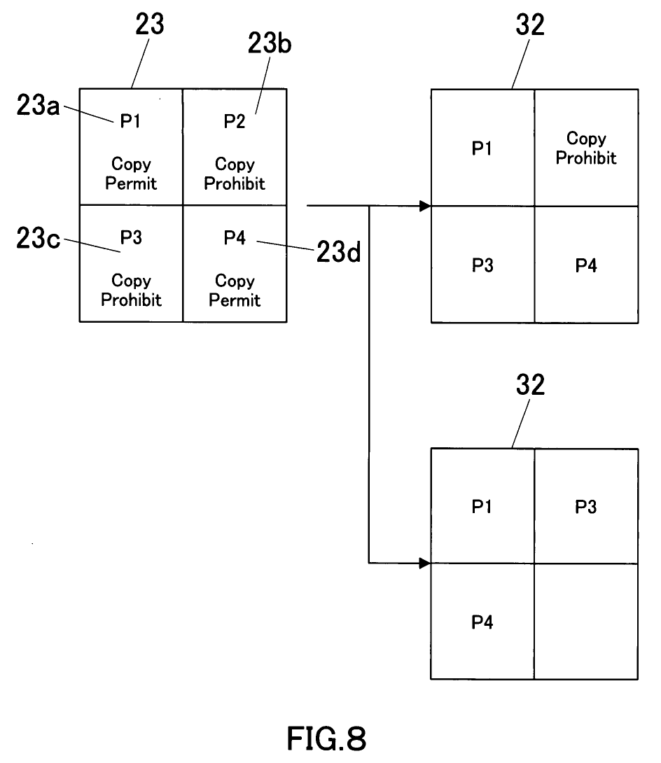

Further, another embodiment will be explained with reference to FIG. 8, wherein the document 23 is copied on the sheet 32, and the document 23 is a sheet having a ground pattern given to each of the four areas 23a through 23d (only the ground pattern given to the area 23b is of “copy prohibit”) by the 4 in 1 mode.

As shown in the upper right region of FIG. 8, information for example “copy prohibit” is printed in a particular area on the sheet 32, which corresponds to the area 23b, so as to notify the image is prohibited to be copied. Alternatively, permitted images P3 and P4 from the areas 23c and 23d following the copy prohibit area 23b, are printed in particular areas on the sheet 32, which correspond to the areas 23b and 23c, without a space for the prohibited image.

According to the image operations explained with reference to FIG. 7 and FIG. 8, a user such as an owner user of the document 23 recognizes the document has an image prohibited from being copied, or he/she obtains an outputted sheet that looks better without a strange blank space that is shown when an image read out from a copy prohibit area is not outputted.

Further, if the detected security code is “copy prohibit”, a message can be displayed in a screen 52a on a display 52 of the operation panel 5, for example “the ‘copy prohibit’ security code is detected out. The image will be outputted by *** mode.” as shown in FIG. 9. In this way, a user such as an owner user of the document recognizes more easily that the document has an image prohibited from being copied.

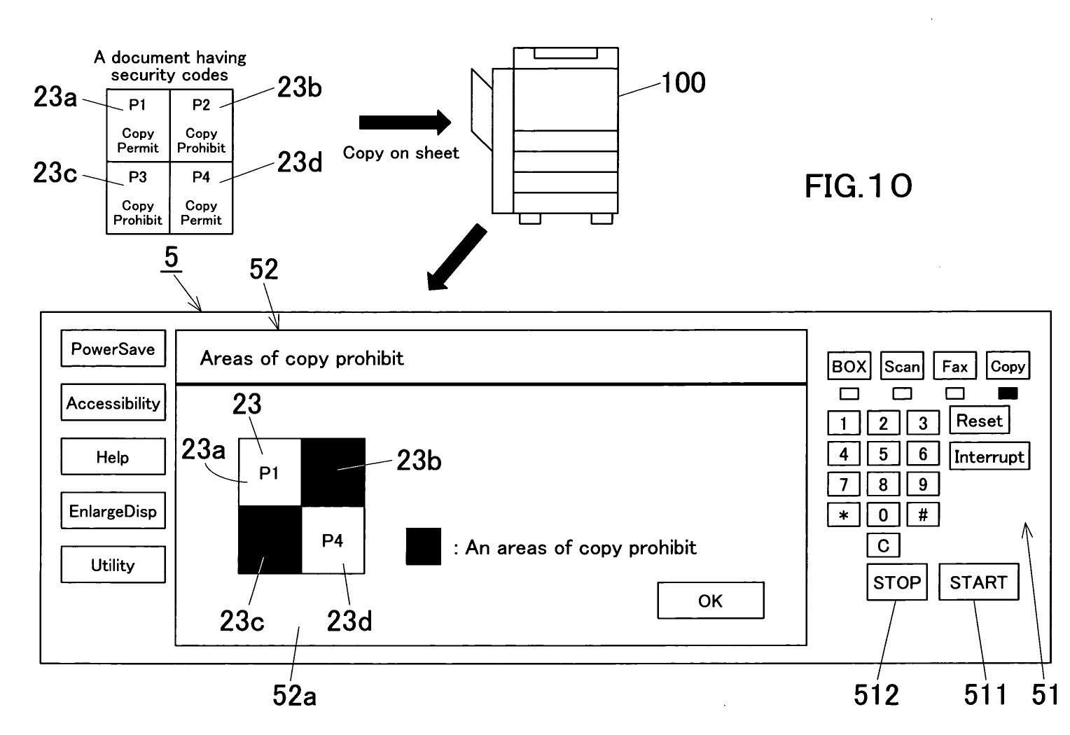

Further, as shown in FIG. 10, areas of “copy prohibit” (the areas 23b and 23c in FIG. 10) can be displayed on the display 52 of the operation panel 5. In this embodiment, the areas of “copy prohibit” are marked in black. In this way, a user trying to copy the document recognizes more easily that the document contains some images prohibited to be copied.

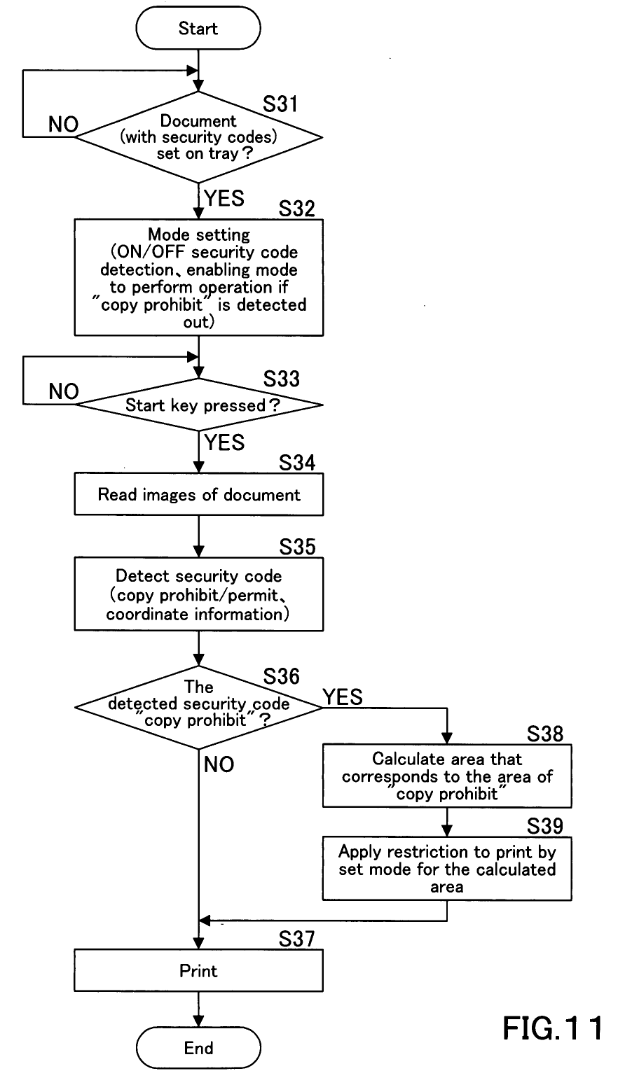

FIG. 11 is a flowchart showing a procedure performed when a security code is detected. The processes are also executed by the CPU 1 according to an operation program recorded in a recording medium such as the ROM 2.

In this embodiment, pages of a document are set separately one by one on a document table to be copied on a sheet.

As shown in FIG. 11, the routine waits until a document is set in Step S31, and if a document is set (YES in Step S31), mode settings are performed according to user operations in Step S32. The mode settings are enabling/disabling (ON/OFF) the mode to detect a security code, enabling the mode to perform an operation if the mode to detect a security code is enabled and the detected security code is “copy prohibit”, etc.

Then in Step S33, the routine waits until the start key 511 is pressed, and if the start key 511 is pressed (YES in Step S33), images of a document are started to be read by the scanner 4 in Step S34.

A security code is detected in Step S35, and it is judged in Step S36 whether or not the detected security code is “copy prohibit”. If the detected security code is not “copy prohibit” (NO in Step S36), the images are printed in Step S37, and then the routine terminates.

If the detected security code is “copy prohibit” (YES in Step S36), an area to be outputted on a sheet, which corresponds to the area of “copy prohibit”, is calculated based on the security code information in Step S38. In Step S39, the restriction to print by the pre-set mode (copy prohibit) is applied to the calculated area on a sheet to be outputted, which corresponds to the area of “copy prohibit”. Then, the sheet is printed out under the restriction in Step S37, and then the routine terminates.

As described above in this embodiment, when a document is copied on a sheet and the document is a sheet having images printed in a plurality of areas thereon by the N in 1 mode and also having a security code given to each of the areas, each security code is detected out, then printing of image data read out from each of the areas is controlled depending on the detecting result, which would contribute to flexibility and usability of document security management.

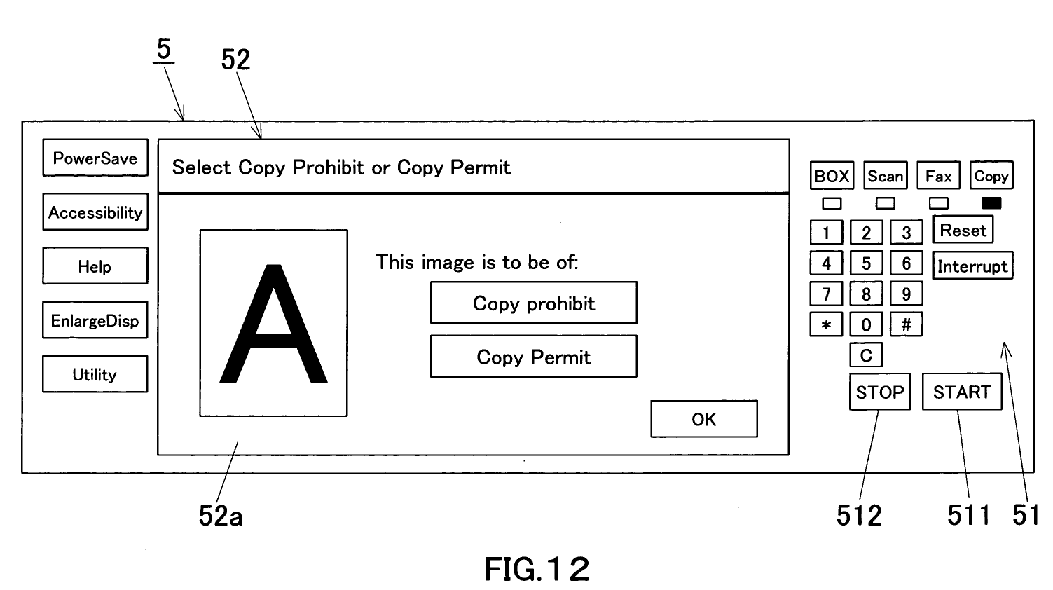

Further in this embodiment, information to be embedded in a ground pattern is entered by a user via the operation panel 5 before images of a document are read. For example, “copy prohibit” is entered for a particular page. The information to be embedded in a ground pattern is varied and some examples will be explained right below.

[1] One page of a document is transferred by an automatic document feeder of the scanner 4. When an image of the page is read, the image and some options of information to be embedded in a ground pattern for the image are displayed on the display 52 of the operation panel 5, as shown in FIG. 12. Then a user selects one from those and the option is decided as the information to be embedded in a ground pattern for the image. These operations are repeated for each page of the document.

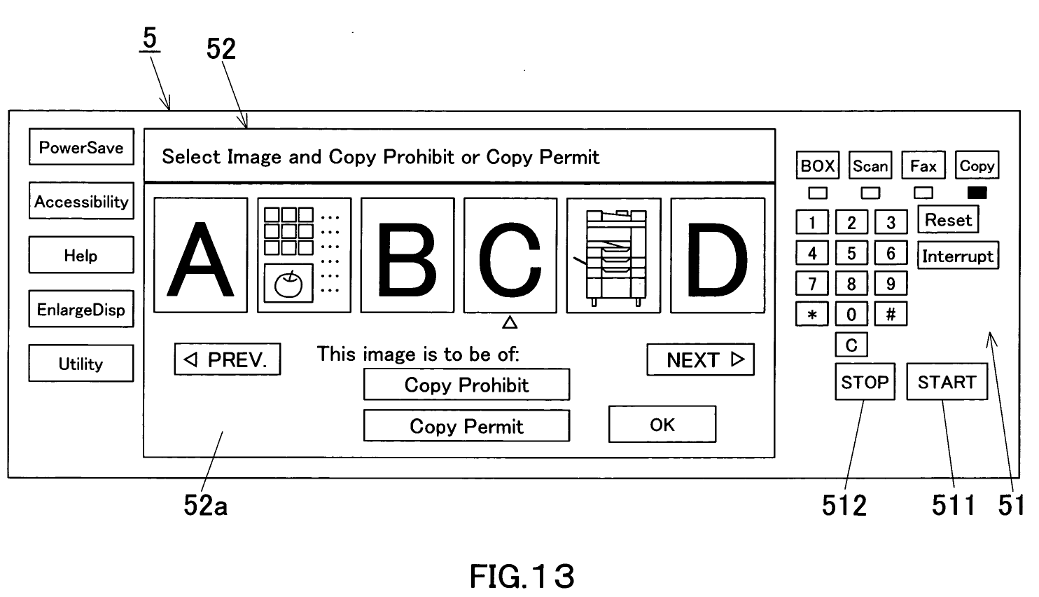

Briefly, a user selects information to be embedded in a ground pattern after each page of a document is read.

[2] All pages of a document are transferred by an automatic document feeder of the scanner 4. After images of all the pages are read, a list of the images and some options of information to be embedded in a ground pattern for the images are displayed on the display 52 of the operation panel 5, as shown in FIG. 13. Then a user selects an image and an option for the image, and the option is decided as the information to be embedded in a ground pattern for the image.

Briefly, a user selects information to be embedded in a ground pattern after all pages of a document are read.

[3] One page of a document is set on a document table of the scanner 4. Then, before or after an image of the page is read, a user enters via the operation panel 5 information to be embedded in a ground pattern for the image. If a user performs entry operation after the image is read, the image and some options of information to be embedded in a ground pattern for the image are displayed on the display 52 of the operation panel 5, like in the way described above in [1].

[4] Pages of a document are set one by one on a document table of the scanner 4. After images of all the pages are read, a user enters via the operation panel 5 information to be embedded in a ground pattern for the images. In this case, a list of the images and some options of information to be embedded in a ground pattern for the images are displayed on the display 52 of the operation panel 5, like in the way described above in [2].

### Summary of the Embodiments

[1] An image processing apparatus can be configured to comprise: a document reader that reads images of a document; a printer that prints on a sheet, image data read out from the document by the document reader; a mode setter that enables the N in 1 mode to print images of N pages of document on one sheet; and a security code giver that gives a security code to each print area on the sheet, in which the image data read out from the document is to be printed, if the N in 1 mode is enabled by the mode setter. And in the image processing apparatus, a controller makes the security code giver to give one security code to one sheet, if the N in 1 mode is not enabled.

According to this image processing apparatus, one security code is given to one sheet like in the conventional way, if the N in 1 mode is not enabled.

[2] A security code indicates copy permit/prohibit set for each page of document, and the image processing apparatus can further comprise a setter that sets copy permit/prohibit for each page of the document.

According to this image processing apparatus, copy permit/prohibit is set for each page of a document, when the document is printed by the N in 1 mode.

[3] An image processing apparatus, wherein a security code is printed as a ground pattern on a sheet simultaneously with image data.

According to this image processing apparatus, a security code is merged to image data as a ground pattern.

[4] An image processing apparatus can be configured to comprise: a document reader that reads images printed in a plurality of areas in a document by the N in 1 mode to print images of N pages of document on one sheet; a printer that prints on a sheet, image data read out from the document by the document reader; a security code detector that detects a security code given to each of the plurality of areas in the document; and a controller that makes the printer print image data read out from each of the areas in a particular way depending on the security code detected out by the security code detector. And in the image processing apparatus, if the security codes detected out by the security code detector from the plurality of areas in the document includes the one indicating copy prohibit, the controller makes the printer output a blank space in a corresponding area on the sheet.

According to this image processing apparatus, if security codes detected out from a plurality of areas in a document includes the one indicating copy prohibit, a blank space is outputted in a corresponding area on a sheet, which prevents an image prohibited to be copied from being leaked to outsiders.

[5] In the image processing apparatus, if the security codes detected out by the security code detector from the plurality of areas in the document includes the one indicating copy prohibit, the controller cancels a print job to print the document.

According to this image processing apparatus, if security codes detected out from a plurality of areas in a document includes the one indicating copy prohibit, a print job to print the document is canceled, which prevents an image prohibited to be copied from being leaked to outsiders.

[6] In the image processing apparatus, if the security codes detected out by the security code detector from the plurality of areas in the document includes the one indicating copy prohibit, the controller makes the printer print information indicating copy prohibit in a corresponding area on the sheet.

According to this image processing apparatus, if security codes detected out from a plurality of areas in a document includes the one indicating copy prohibit, information indicating copy prohibit is printed in a corresponding area on a sheet, which makes a user recognize the document contains an image prohibited to be copied.

[7] In the image processing apparatus, if the security codes detected out by the security code detector from the plurality of areas in the document includes the one indicating copy prohibit, the controller makes the printer print in a different color in a corresponding area on the sheet, an image from an area having the security code indicating copy prohibit.

According to this image processing apparatus, if security codes detected out from a plurality of areas in a document includes the one indicating copy prohibit, an image from an area having the security codes indicating copy prohibit in a different color in a corresponding area on a sheet, which makes a user recognize the document contains an image prohibited to be copied.

[8] In the image processing apparatus, if the security codes detected out by the security code detector from the plurality of areas in the document includes the one indicating copy prohibit, the controller makes the printer print at a different density in a corresponding area on the sheet, an image from an area having the security code indicating copy prohibit.

According to this image processing apparatus, if security codes detected out from a plurality of areas in a document includes the one indicating copy prohibit, an image from an area having the security code indicating copy prohibit is printed at a different density in a corresponding area on a sheet, which makes a user recognize the document contains an image prohibited to be copied.

[9] In the image processing apparatus, if the security codes detected out by the security code detector from the plurality of areas in the document includes the one indicating copy prohibit, the controller makes the printer print at a different scale in a corresponding area on the sheet, an image from an area having the security code indicating copy prohibit

According to this image processing apparatus, if security codes detected out from a plurality of areas in a document includes the one indicating copy prohibit, an image from an area having the security code indicating copy prohibit is printed at a different scale in a corresponding area on a sheet, which makes a user recognize the document contains an image prohibited to be copied.

[10] In the image processing apparatus, if the security codes detected out by the security code detector from the plurality of areas in the document includes the one indicating copy prohibit, the controller makes the printer print without outputting a blank space on the sheet, images from other than an area having the security code indicating copy prohibit.

According to this image processing apparatus, if security codes detected out from a plurality of areas in a document includes the one indicating copy prohibit, a blank space is not outputted; instead, images from other than an area having the security code indicating copy prohibit are printed on a sheet, which brings an outputted sheet that looks better.

[11] In the image processing apparatus, if the security codes detected out by the security code detector from the plurality of areas in the document includes the one indicating copy prohibit, the controller makes the printer rotate and/or enlarge, then print so as to fill in a blank space on the sheet, images from other than an area having the security code indicating copy prohibit.

According to this image processing apparatus, if security codes detected out from a plurality of areas in a document includes the one indicating copy prohibit, images from other than an area having the security code indicating copy prohibit is both rotated and enlarged, then printed so as to fill in a blank space on a sheet, which brings an outputted sheet that looks better.

[12] In the image processing apparatus, if the security codes detected out by the security code detector from the plurality of areas in the document includes the one indicating copy prohibit, the controller makes a display display a message indicating copy prohibit thereon.

According to this image processing apparatus, if security codes detected out from a plurality of areas in a document includes the one indicating copy prohibit, a message indicating copy prohibit is displayed on a display, which makes a user recognize the document contains an image prohibited to be copied.

[13] In the image processing apparatus, if the security codes detected out by the security code detector from the plurality of areas in the document includes the one indicating copy prohibit, the controller makes the display display an area having the security code indicating copy prohibit thereon.

According to this image processing apparatus, if security codes detected out from a plurality of areas in a document includes the one indicating copy prohibit, an area having the security code indicating copy prohibit is displayed on a display, which makes a user recognize the document contains an image prohibited to be copied.

[14] The security code is printed as a ground pattern on the sheet simultaneously with the image data.

In this case, a security code is printed as a ground pattern on a sheet simultaneously with image data, thus the security code can be treated as image data.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image processing apparatus, comprising:
a document reader that reads images of a document;
a printer that prints on a sheet, image data read out from the document by said document reader;
a mode setter that enables the N in 1 mode to print images of N pages of document on one sheet; and
a security code giver that gives a security code to each print area on said sheet, in which the image data read out from the document is to be printed, if the N in 1 mode is enabled by said mode setter.

2. An image processing apparatus as recited in claim 1, wherein said controller makes said security code giver give one security code to one sheet if the N in 1 mode is not enabled.

3. An image processing apparatus as recited in claim 1 further comprising a setter that sets copy permit/prohibit for each page of the document, wherein said security code indicates copy permit/prohibit set for each page of the document.

4. An image processing apparatus as recited in claim 1, wherein said security code is printed as a ground pattern on the sheet simultaneously with the image data.

5. An image processing apparatus, comprising:
a document reader that reads images printed in a plurality of areas in a document by the N in 1 mode to print images of N pages of document on one sheet;
a printer that prints on a sheet, image data read out from the document by said document reader;
a security code detector that detects a security code given to each of the plurality of areas in said document; and
a controller that makes said printer print image data read out from each of the areas, depending on the security code detected out by said security code detector.

6. An image processing apparatus as recited in claim 5, wherein if security codes detected out by said security code detector from said plurality of areas in the document includes the one indicating copy prohibit, said controller makes the printer output a blank space in a corresponding area on the sheet.

7. An image processing apparatus as recited in claim 5, wherein if security codes detected out by said security code detector from said plurality of areas in the document includes the one indicating copy prohibit, said controller cancels a print job to print the document.

8. An image processing apparatus as recited in claim 5, wherein if security codes detected out by said security code detector from said plurality of areas in the document includes the one indicating copy prohibit, said controller makes the printer print information indicating copy prohibit.

9. An image processing apparatus as recited in claim 5, wherein if security codes detected out by said security code detector from said plurality of areas in the document includes the one indicating copy prohibit, said controller makes the printer print in a different color, image data read out from an area having the security code indicating copy prohibit.

10. An image processing apparatus as recited in claim 5, wherein if security codes detected out by said security code detector from said plurality of areas in the document includes the one indicating copy prohibit, said controller makes the printer print at a different density, image data read out from an area having the security code indicating copy prohibit.

11. An image processing apparatus as recited in claim 5, wherein if security codes detected out by said security code detector from said plurality of areas in the document includes the one indicating copy prohibit, said controller makes the printer print at a different scale, image data read out from an area having the security code indicating copy prohibit.

12. An image processing apparatus as recited in claim 5, wherein if security codes detected out by said security code detector from said plurality of areas in the document includes the one indicating copy prohibit, said controller makes the printer print image data read out from other than an area having the security code indicating copy prohibit with their positions moved forward, instead of image data read out from the area having the security code.

13. An image processing apparatus as recited in claim 5, wherein if security codes detected out by said security code detector from said plurality of areas in the document includes the one indicating copy prohibit, said controller makes the printer rotate and/or enlarge, then print so as to fill in a blank space on the sheet, image data read out from other than an area having the security code indicating copy prohibit.

14. An image processing apparatus as recited in claim 5 further comprising a display, wherein if security codes detected out by said security code detector from said plurality of areas in the document includes the one indicating copy prohibit, said controller makes said display display a message indicating copy prohibit thereon.

15. An image processing apparatus as recited in claim 5 further comprising a display, wherein if security codes detected out by said security code detector from said plurality of areas in the document includes the one indicating copy prohibit, said controller makes said display display an area having the security code indicating copy prohibit thereon.

16. An image processing apparatus as recited in claim 5, wherein said security code is printed as a ground pattern on the sheet simultaneously with the image data.

17. An image processing method, comprising:
reading images of a document;
enabling the N in 1 mode to print images of N pages of document on one sheet; and giving a security code by the N in 1 mode to each area on a sheet, in which image data read out from the document is to be printed, if the N in 1 mode is enabled.

18. An image processing method, comprising:
reading images printed in a plurality of areas in a document by the N in 1 mode to print images of N pages of document on one sheet;
printing image data read out from said document on a sheet;
detecting a security code given to each of the plurality of areas in said document; and
making said printer print image data read out from each of the areas, depending on said detected security code.

19. A recording medium having an image processing program recorded therein to make a computer in the image processing apparatus execute:
reading images of a document;
enabling the N in 1 mode to print images of N pages of document on one sheet; and giving a security code to each area on a sheet, in which image data read out from the document is to be printed, if the N in 1 mode is enabled.

20. A recording medium having an image processing program recorded therein to make a computer in the image processing apparatus execute:
reading images printed in a plurality of areas in a document by the N in 1 mode to print images of N pages of document on one sheet;
printing image data read out from said document on a sheet;
detecting a security code given to each of the plurality of areas in said document; and
making said printer print image data read out from each of the areas, depending on said detected security code.
